(19) United States
(12) Patent Application Publication
(10) Pub. No.: US 2026/0367262 A1
(43) Pub. Date: Nov. 19, 2026

(54) RADIATION DETECTION APPARATUS AND RADIATION DETECTION SYSTEM

(71) Applicant: CANON KABUSHIKI KAISHA, Tokyo (JP)

(72) Inventors: TOMONA YAMAGUCHI, Tokyo (JP); TAKANORI WATANABE, Kanagawa (JP)

(21) Appl. No.: 19/662,145

(22) Filed: Apr. 29, 2026

(30) Foreign Application Priority Data
May 16, 2025 (JP) 2025-082855

(51) Int. Cl. G01T 1/24

(52) U.S. Cl. CPC G01T 1/24

(57) ABSTRACT

A radiation detection apparatus including a substrate including a semiconductor layer, a detector including a pixel array region including a plurality of pixels provided in the semiconductor layer so as to detect radiation and a peripheral circuit region having a circuit provided in the semiconductor layer so as to drive the plurality of pixels, and a plurality of terminals provided on the substrate and configured to connect the detector to outside of the detector, is provided. The plurality of terminals include a first terminal used for one of current input and output operations for heating the semiconductor layer and a second terminal used for the other of the current input and output operations, and the current flows between the first terminal and the second terminal via part of the semiconductor layer.

### BACKGROUND

### Field of the Technology

The present disclosure relates to a radiation detection apparatus and a radiation detection system.

### Description of the Related Art

When a radiation detection apparatus is driven for a long time, a defect is formed near the interface between a semiconductor layer and an insulating layer such as a gate insulating film due to irradiation with radiation, thus causing deterioration such as characteristic variation in pixels. Japanese Patent Laid-Open No. 2011-176235 discloses that the deterioration of the transistor provided in a pixel is rectified by heating the transistor by making an annealing current flow therein.

Deterioration originating from the formation of a crystal defect can occur in the photodiode provided in a pixel as well as in the transistor.

### SUMMARY

Some embodiments provide techniques advantageous in rectifying deterioration.

According to some embodiments, a radiation detection apparatus comprising: a substrate including a semiconductor layer; a detector including a pixel array region including a plurality of pixels provided in the semiconductor layer so as to detect radiation and a peripheral circuit region having a circuit provided in the semiconductor layer so as to drive the plurality of pixels; and a plurality of terminals provided on the substrate and configured to connect the detector to outside of the detector, wherein the plurality of terminals include a first terminal used for one of current input and output operations for heating the semiconductor layer and a second terminal used for the other of the current input and output operations, and the current flows between the first terminal and the second terminal via part of the semiconductor layer, is provided.

Features of the present disclosure will become apparent from the following description of embodiments with reference to the attached drawings. The following description of embodiments is described by way of example.

### BRIEF DESCRIPTION OF THE DRAWINGS

FIG. 1 is a plan view showing a configuration example of a radiation detection apparatus according to the present embodiment;

FIG. 2 is a plan view showing a configuration example of the detector of the radiation detection apparatus in FIG. 1;

FIG. 3 is a sectional view showing a configuration example of the detector of the radiation detection apparatus in FIG. 1;

FIG. 4 is a sectional view showing a configuration example of a pixel of the radiation detection apparatus in FIG. 1;

FIG. 5 is a sectional view showing a configuration example of a protective diode of the radiation detection apparatus in FIG. 1;

FIGS. 6A and 6B are respectively a sectional view showing a configuration example of the detector of the radiation detection apparatus in FIG. 1 and a plan view showing a placement example of contacts;

FIG. 7 is a sectional view showing a configuration example of the detector of the radiation detection apparatus in FIG. 1;

FIG. 8 is a sectional view showing a configuration example of the detector of the radiation detection apparatus in FIG. 1;

FIG. 9 is a sectional view showing a configuration example of the detector of the radiation detection apparatus in FIG. 1;

FIG. 10 is a view showing a configuration example of a radiation detection system including the radiation detection apparatus according to the present embodiment; and

FIGS. 11A and 11B are schematic views respectively showing equipment and a transmission electron microscope, each serving as a radiation detection system including the radiation detection apparatus according to the present embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

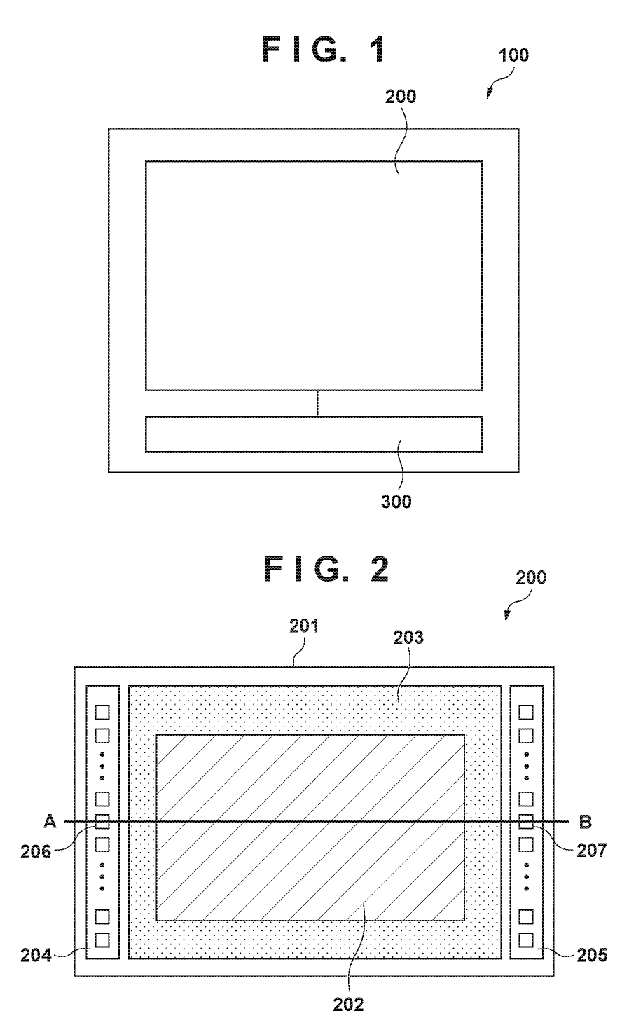

A radiation detection apparatus according to an embodiment of the present disclosure will be described with reference to FIGS. 1-9. FIG. 1 is a plan view showing a configuration example of a radiation detection apparatus 100 according to the present embodiment. In this case, radiation in the present embodiment includes particle radiation (α-rays, β-rays, electron beam, and proton beam) as ionizing radiation, electromagnetic waves (X-rays and γ-rays), and non-ionizing radiation (visible rays, infrared rays, and ultraviolet rays). The radiation detection apparatus 100 includes a detector 200 and a control circuit 300. The control circuit 300 is configured to be able to control the operation of the detector 200 in a plurality of operation modes. This enables the detector 200 to perform an operation of detecting radiation and an operation for rectifying driving deterioration due to irradiation.

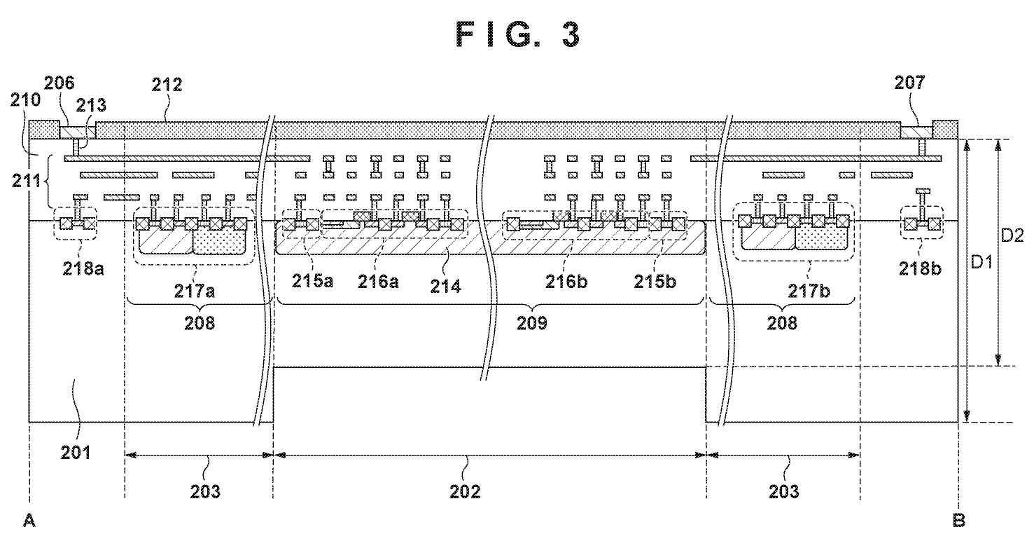

FIG. 2 is a plan view showing a configuration example of the detector 200. FIG. 3 is a sectional view taken along A - B in FIG. 2. The detector 200 is formed on a substrate 201 including a semiconductor layer. In the present embodiment, the substrate 201 is a semiconductor substrate using silicon or the like. Accordingly, the semiconductor layer can be read as the substrate 201. However, the substrate 201 is not limited to a semiconductor substrate but may be a structure obtained by stacking an insulating layer made of glass or resin and a semiconductor layer.

The detector 200 includes a pixel array region 202 having a plurality of pixels 216 provided in a semiconductor layer (which can be read as the substrate 201 in the present embodiment as described above) so as to detect radiation and a peripheral circuit region 203 having circuits provided in the semiconductor layer to drive the plurality of pixels 216. In addition, the detector 200 has a plurality of terminals 206 and 207 provided on the substrate 201 to connect the detector 200 to the outside of the detector 200.

The plurality of pixels 216 are, for example, two-dimensionally arrayed in the pixel array region 202. As shown in FIG. 2, the pixel array region 202 may have a substantially rectangular shape in planar view. In this case, "planar view" indicates orthogonal projection to the surface, of the substrate 201, which is provided with the pixel array region 202 or the peripheral circuit region 203. The pixel 216 accumulates the charge generated by irradiation with radiation and outputs a pixel signal corresponding to the amount of accumulated charge. The pixel array region 202 may be provided with only so-called effective pixels. In addition, an outer edge portion of the pixel array region 202 may be provided with dummy pixels which are ineffective pixels. The pixel array region 202 is a region including all these pixels.

The peripheral circuit region 203 is provided with a circuit such as a signal processing circuit which is provided in an outer peripheral portion adjacent to the pixel array region 202 and processes the pixel signals output from the plurality of pixels 216. In the configuration shown in FIG. 2, the peripheral circuit region 203 is provided so as to surround the pixel array region 202, but limitation is not made thereto. For example, the peripheral circuit region 203 may be provided so as to extend along one, two, or three sides of the four sides of the rectangular pixel array region 202.

The plurality of terminals 206 are provided in a terminal region 204. The plurality of terminals 207 are provided in a terminal region 205. The terminal regions 204 and 205 are provided along the outer periphery of the peripheral circuit region 203 having a rectangular shape in planar view. The terminal region 204 is provided with the plurality of terminals 206 arranged along one side of the peripheral circuit region 203 having a substantially rectangular shape. The terminal region 205 is provided with the plurality of terminals 207 arranged along a side of the peripheral circuit region 203 which faces the side along which the terminal region 204 extends. The terminals 206 and 207 each are used for inputting and outputting at least one of a voltage and a current. The terminals 206 and 207 are connected to the control circuit 300. The terminals 206 and 207 each may be used as a terminal dedicated to a radiation detecting operation or a deterioration rectifying operation or may serve as a terminal for the two operations. In addition, at the time of performing a radiation detecting operation and a deterioration rectifying operation, an arbitrary number of terminals 206 of the plurality of terminals 206 can be concurrently used. Likewise, at the time of performing a radiation detecting operation and a deterioration rectifying operation, an arbitrary number of terminals 207 of the plurality of terminals 207 can be concurrently used. The terminals 206 and 207 can also be called pads or the like.

The pixel array region 202 is provided between the terminal region 204 provided with the terminals 206 and the terminal region 205 provided with the terminals 207. As described later, this makes it possible to make a current flow between a terminal 206a, of the plurality of terminals 206, which is used for one of current input and output operations for heating the semiconductor layer and a terminal 207a, of the plurality of terminals 207, which is used for the other of the current input and output operations via part of the semiconductor layer. This makes it possible to heat the pixel array region 202 and perform a deterioration rectifying operation. In addition, the terminal 206a is provided along one side of the rectangle shape of the pixel array region 202, and the terminal 207a is provided along another side facing the side along which the terminal 206a is provided. This can facilitate the layout of wiring for making a current flow in the semiconductor layer at the time of a deterioration rectifying operation.

As shown in FIG. 3, a pixel array 209 provided with the plurality of pixels 216 is formed in the pixel array region 202 of the principal surface of the substrate 201. In addition, a peripheral circuit 208 is formed in the peripheral circuit region 203 of the principal surface of the substrate 201. As shown in FIG. 3, a thickness D2 of the pixel array region 202 of the semiconductor layer (the substrate 201) is smaller than a thickness D1 of the peripheral circuit region 203 of the semiconductor layer (the substrate 201). The effect of thinning the pixel array region 202 will be described later.

A structure including an interlayer dielectric film 210, a plurality of wiring layers (conductor layers) 211, and a passivation layer 212 is stacked on the substrate 201. The interlayer dielectric film 210 is formed by an insulator. The wiring layers 211 are arranged in the interlayer dielectric film 210. The passivation layer 212 is provided on the interlayer dielectric film 210. The terminals 206 and 207 are connected to the semiconductor layer of the substrate 201 through the plurality of wiring layers 211 and contacts 213. The substrate 201 is provided with a plurality of semiconductor regions having different conductivity types (polarities). A configuration in which n-type and p-type semiconductor regions are formed in the n-type substrate 201 will be described below. However, the conductivity types of the respective regions, including the substrate 201, may be changed, for example, inverted. A well 214 in the pixel array region 202 is a p-type semiconductor region. As shown in FIG. 3, the region provided with the well 214 may be defined as the pixel array region 202. The well 214 is provided with the pixel 216 and a well contact portion 215. A protective diode 217 may be provided as part of a circuit provided in the peripheral circuit region 203, as shown in FIG. 3. In addition, the outer edge of the peripheral circuit region 203 may be provided with a substrate contact portion 218.

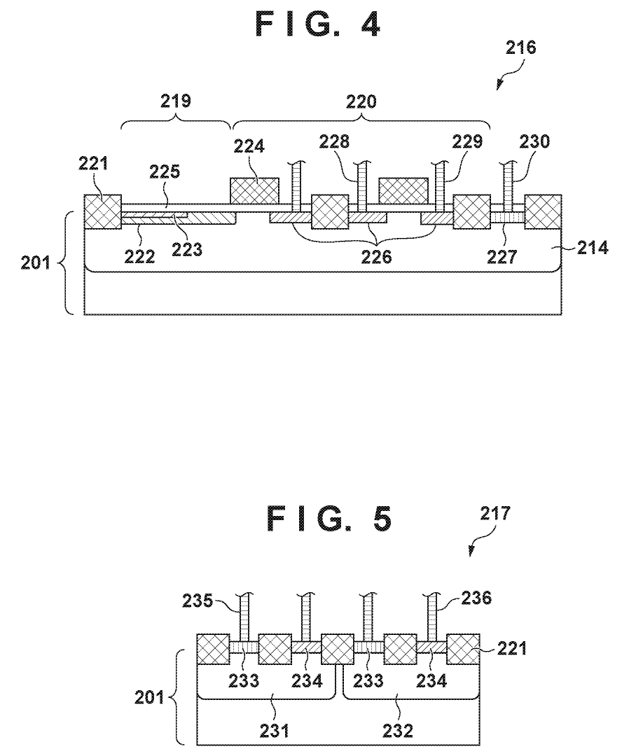

FIG. 4 is a sectional view showing a configuration example of the pixel 216 provided in the pixel array region 202. Referring to FIG. 4, an illustration of the configuration located above the interlayer dielectric film 210 and the wiring layer 211 is omitted. The pixel 216 includes a radiation detection region 219 and a transistor region 220. As described above, the pixel 216 is formed in the p-type well 214 provided in the n-type substrate 201. The radiation detection region 219 is provided with an n-type semiconductor region 222 constituting a photodiode as a radiation detection element. A semiconductor region 223 is a region into which a p-type impurity is implanted to form a photodiode having an embedded structure. The transistor region 220 is provided with a gate electrode 224, and a thin silicon oxide 225 is stacked on the surface of the substrate 201 except for an element isolation region 221. In addition, the transistor region 220 is provided with an n-type diffusion region 226 and a p-type diffusion region 227 each functioning as a source or drain region. Contacts 228, 229, and 230 formed by using a metal such as tungsten are in contact with the diffusion regions 226 and 227. The radiation detection region 219 can be provided with an appropriate photodiode in accordance with the type of radiation to be applied. Alternately, a wavelength conversion material such as a scintillator may be used in addition to the photodiode. The scintillator can be stacked on, for example, the interlayer dielectric film 210 or the passivation layer 212.

FIG. 5 is a sectional view showing a configuration example of the protective diode 217 provided in the peripheral circuit region 203. Referring to FIGS. 5, like 4, an illustration of the configuration above the interlayer dielectric film 210 and the wiring layer 211 is omitted. The protective diode 217 has a p-type well 231 and an n-type well 232 formed in the n-type substrate 201. In addition, the protective diode 217 has a p-type diffusion region 233 and an n-type diffusion region 234 provided in the wells 231 and 232. The diffusion regions 233 and 234 are isolated from each other by the element isolation region 221. Contacts 235 and 236 formed by using a metal such as tungsten are in contact with the diffusion regions 233 and 234.

As described above, the control circuit 300 is configured to be able to control the operation of the detector 200 in a plurality of operation modes. The plurality of operation modes include the first mode of performing a deterioration rectifying operation and the second mode of performing a radiation detecting operation by operating the plurality of pixels 216. In the first mode of performing a deterioration rectifying operation, the control circuit 300 performs control to make a current flow between the terminal 206a, of the plurality of terminals 206, which is used for one of current input and output operations for heating the semiconductor layer and the terminal 207a, of the plurality of terminals 207, which is used for the other of the current input and output operations. Making a current flow in the semiconductor layer in which the photodiode is formed will heat the semiconductor layer, thereby rectifying the deteriorated photodiode in the second mode of performing a radiation detecting operation.

In the first mode of performing a deterioration rectifying operation, the control circuit 300 need not operate the plurality of pixels 216. For example, in the first mode, the control circuit 300 performs control to make terminals, of the plurality of terminals 206 and 207, which are used to operate the plurality of pixels 216 float. In addition, for example, all the terminals, of the plurality of terminals 206 and 207, which are not used in the first mode of performing a deterioration rectifying operation are made to float. Accordingly, no voltage is applied to active elements such as a transistor of the pixel 216. Therefore, a voltage higher than the withstand voltage in the second mode of performing a radiation detecting operation can be applied between the terminal 206a and the terminal 207a used in the first mode of performing a deterioration rectifying operation.

Consider a case where a contact that is in contact with the semiconductor layer so as to electrically connect the terminal 206a to the semiconductor layer and a contact that is in contact with the semiconductor layer so as to electrically connect the terminal 207a to the semiconductor layer are in contact with semiconductor regions having the same polarity. In this case, it is possible to supply power to the heating portion of the semiconductor layer from a power source without going through any active element. It is therefore possible to apply a voltage higher than the withstand voltage of the active element and increase the amount of heat generated in the first mode of performing a deterioration rectifying operation.

Consider a case where a contact that is in contact with the semiconductor layer so as to electrically connect the terminal 206a to the semiconductor layer and a contact that is in contact with the semiconductor layer so as to electrically connect the terminal 207a to the semiconductor layer are in contact with semiconductor regions having different polarities. In this case, in supplying power from the power source to the heating portion of the semiconductor layer without going through any active element, it is possible to use a pn-junction forward current. For example, the power source terminals of the protective diode 217 can also be used as the terminals 206a and 207a. In this case also, it is possible to increase the amount of heat generated in the first mode of performing a deterioration rectifying operation by applying a voltage exceeding the withstand voltage of the active element.

As described above, the thickness D2 of the pixel array region 202 of the semiconductor layer may be smaller than the thickness D1 of the peripheral circuit region 203. The thickness D1 of the peripheral circuit region 203 may fall within the range of 100 μm or more to 500 μm or less. On the other hand, the thickness D2 of the pixel array region 202 may fall within, for example, the range of 10 μm or more to 100 μm or less, and may also be 50 μm or less. Thinning the semiconductor layer (the substrate 201) makes it possible to suppress heat conduction from the pixel array region 202 to the peripheral circuit region 203 and efficiently heat the pixel array region 202.

The control circuit 300 performs control to respectively supply the first potential and the second potential to the terminal 206a and the second potential to the terminal 207a used at the time of performing a deterioration rectifying operation in the second mode of performing a radiation detecting operation. The first potential and the second potential may be equal to each other. This makes it possible to perform a radiation detecting operation without making a current flow between the terminal 206a and the terminal 207a. In contrast to this, in the first operation mode of performing a deterioration rectifying operation, the control circuit 300 performs control to supply the third potential higher than the first and second potentials to the terminal 206a or the terminal 207a. Accordingly, heat is generated in the semiconductor layer between the first terminal and the second terminal, thereby rectifying the deterioration of the photodiode. The amount of heat generated may be 1 W or more.

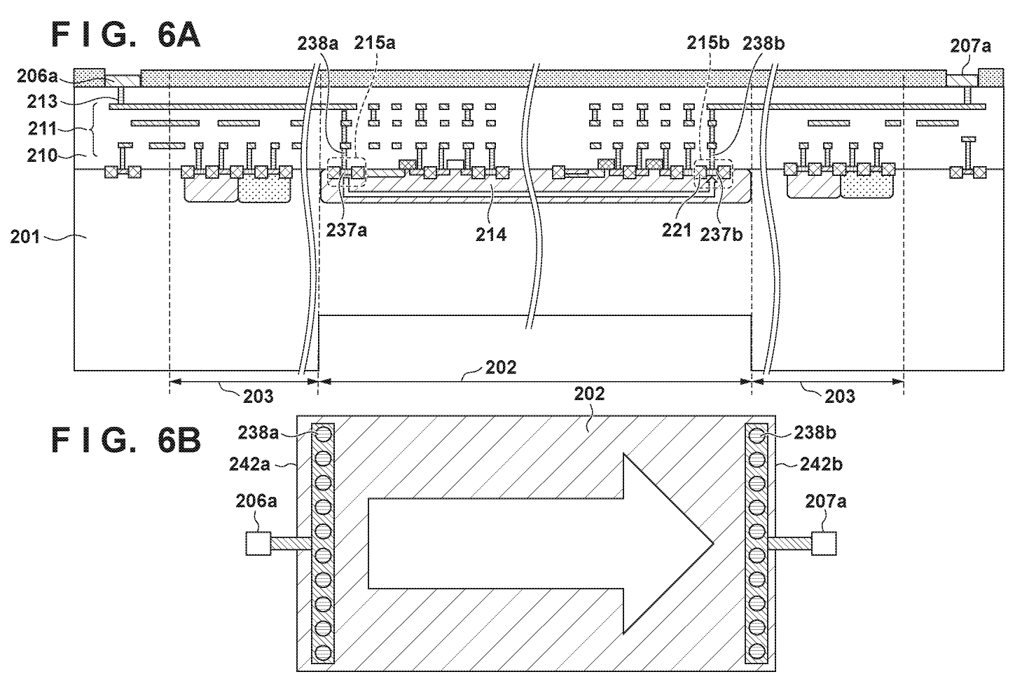

FIG. 6A shows the path along which a current flows between the terminal 206a and the terminal 207a in the first mode of performing a deterioration rectifying operation. In the following description, a current flows from the terminal 206a to the terminal 207a via the semiconductor layer (the substrate 201). However, the control circuit 300 may perform control to make a current flow from the terminal 207a to the terminal 206a. In the configuration shown in FIG. 6A, the p-type well 214 is provided with well contact portions 215a and 215b dedicated to the first mode of performing a deterioration rectifying operation.

The well contact portion 215a is provided with a diffusion region 237a as a p-type semiconductor region. The well contact portion 215b is provided with a diffusion region 237b as a p-type semiconductor region. The diffusion regions 237a and 237b are semiconductor regions having the same polarity as that of the well 214. The diffusion region 237a is in contact with a contact 238a. The diffusion region 237a is electrically connected to the terminal 206a via the predetermined wiring layer 211 and the contact 213. A contact 238b is in contact with the diffusion region 237b. The diffusion region 237b is electrically connected to the terminal 207a via the predetermined wiring layer 211 and the contact 213. The diffusion region 237a and the diffusion region 237b are surrounded by the element isolation region 221. In this configuration, the terminals 206a and 207a are connected to the p-type well 214 in the pixel array region 202 via the contacts 238a and 238b. At least one of the plurality of pixels 216 is provided between the contact 216a that is in contact with the semiconductor layer so as to electrically connect the terminal 206a to the semiconductor layer and the contact 238b that is in contact with the semiconductor layer so as to electrically connect the terminal 207a to the semiconductor layer. This makes it possible to rectify the deterioration of the transistor and photodiode of the pixel 216 in the first mode of performing a deterioration rectifying operation.

As shown in FIG. 6B, a plurality of contacts 238a that are electrically connected to the terminal 206a may be provided. Likewise, a plurality of contacts 238b that are electrically connected to the terminal 207a may be provided. The pixel array region 202 may have a substantially rectangular shape having sides 242a and 242b facing each other. The plurality of contacts 238a may be provided along the side 242a, and the plurality of contacts 238b may be provided along the side 242b. The plurality of contacts 238a arrayed in a line are connected to each other by a predetermined wiring pattern provided on the wiring layer 211 and are connected to the terminal 206a. Likewise, the plurality of contacts 238b arrayed in a line are connected to each other by a predetermined wiring pattern provided on the wiring layer 211 and are connected to the terminal 207a. With this configuration, as shown in FIGS. 6A and 6B, all the plurality of pixels 216 provided in the pixel array region 202 may be provided between the contacts 238a and the contacts 238b.

In the present embodiment, in the second mode of performing a radiation detecting operation, for example, the control circuit 300 performs control to respectively supply 0 V as the first potential to the terminal 206a and 0 V as the second potential to the terminal 207a. The first and second potentials may be equal to the ground level potential. After the radiation detection apparatus 100 is driven for a predetermined time in the second mode, the first mode of performing a deterioration rectifying operation is performed. In the first mode, the control circuit 300 performs control to supply, for example, a potential in the range of 3 V to 100 V or in the range of 5 V to 30 V as the first potential to the terminal 206a and supply a potential of 0 V to the terminal 207a. The configuration shown in FIG. 6B is provided with one each of the terminal 206a and the terminal 207a. However, a current may be made to flow by using the plurality of terminals 206a and 207a connected in parallel. As indicated by the arrow in FIGS. 6A and 6B, a current flows from the terminal 206a to the terminal 207a through the contact 238a, the p-type diffusion region 237a, the p-type well 214, the p-type diffusion region 237b, and the contact 238b.

For example, at least part of the pixel array region 202 may be heated to 80°C or more by making a current flow. In addition, for example, the control circuit 300 may perform control to make a current continuously flow between the terminal 206a and the terminal 207a for 2 hr or more. For example, heating is performed under conditions such as a heating time of 4 hr and a heating temperature of 80°C. This will heat the well 214 and directly heat the interface with the p-type well 214 of the n-type semiconductor region 222 of the photodiode provided in the radiation detection region 219. Likewise, the transistor provided in the transistor region 220 is heated. As a result, the characteristics of the radiation detection apparatus 100 are rectified.

As shown in FIG. 6B, arranging the plurality of contacts 238a and 238b electrically parallel to each other can make a current as the sum of currents flowing in the plurality of contacts 238a and 238b flow to the pixel array region 202. This makes it possible to increase the amount of heat generated in the first mode of performing a deterioration rectifying operation.

In the present embodiment, the well contact portions 215a and 215b dedicated to the first mode of performing a deterioration rectifying operation are provided, the contact 238a and the contact 238b are connected to the semiconductor regions having the same polarity, and currents are made to flow in the semiconductor layers (wells 214) having the same polarity. This makes it possible to supply power from the power source to the heating portion without going through any active elements. Accordingly, it is possible to apply a voltage exceeding the withstand voltage of the active element between the terminal 206a and the terminal 207a and increase the amount of heat generated in the first mode.

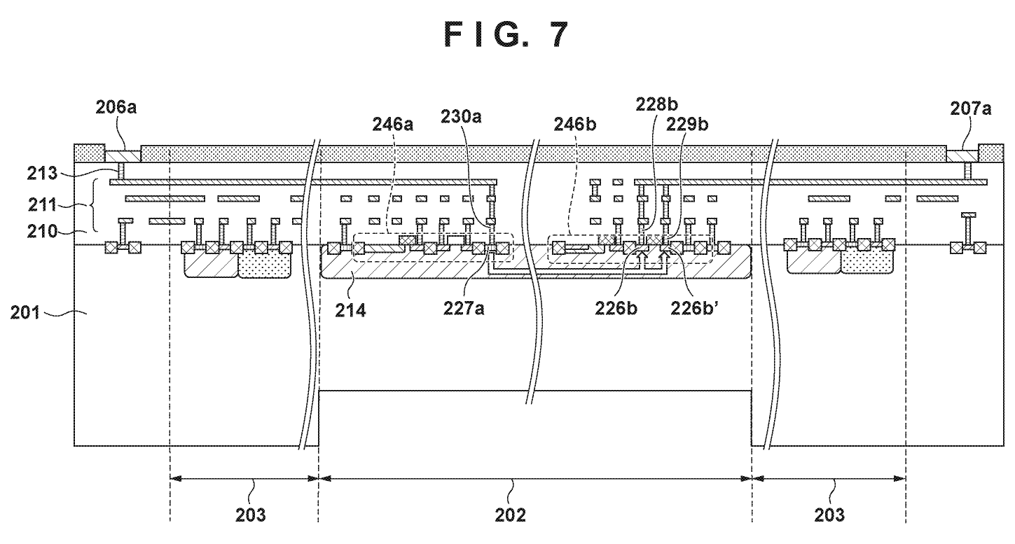

FIG. 7 shows a modification of the configuration shown in FIG. 6A. As described above, the configuration shown in FIG. 6A is provided with the well contact portions 215a and 215b dedicated to the first mode. In the configuration shown in FIG. 7, in the first mode, dummy pixels 246a and 246b provided at end portions of the pixel array region 202 are used for heating. The dummy pixel 246a is provided with a diffusion region 227a as a p-type semiconductor region, and the dummy pixel 246b is provided with diffusion regions 226b and 226b’ as n-type semiconductor regions. A contact 230a is in contact with the diffusion region 227a. The diffusion region 227a and the terminal 206a are electrically connected to each other via the predetermined wiring layer 211 and the contact 213. Contacts 228b and 229b are in contact with the diffusion regions 226b and 226b’, and the diffusion regions 226b and 226b’ and the terminal 207a are electrically connected to each other via the predetermined wiring layer 211 and the contact 213. Other configurations may be the same as those shown in FIG. 6A. As indicated by the arrow in FIG. 7, a current flows from the terminal 206a to the terminal 207a through the contact 230a, the p-type diffusion region 227a, the p-type well 214, the n-type diffusion regions 226b and 226b’, and the contacts 228b and 229b.

In the present embodiment, the contacts 230a, 228b, and 229b are connected to the diffusion regions 227a, 226b, and 226b’ of the dummy pixels 246a and 246b without providing the well contact portions 215a and 215b dedicated to heating. This makes it possible to execute a deterioration rectifying operation only with the existing configuration used for a radiation detecting operation. Although in the configuration shown in FIG. 7, the n-type diffusion regions 226b and 226b’ of the dummy pixel 246b are connected to the terminal 207a, the p-type diffusion region of the dummy pixel 246b may be connected to the terminal 207a.

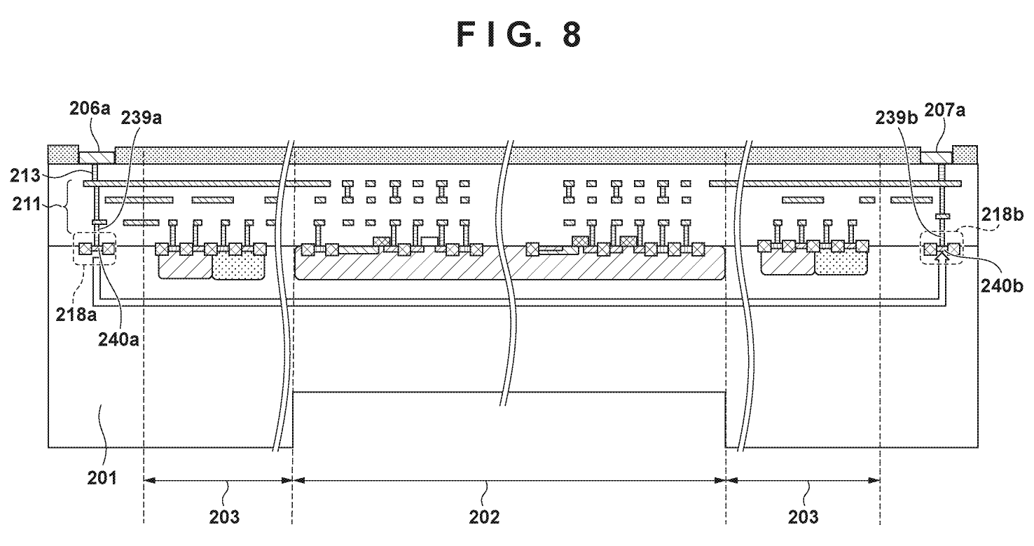

FIG. 8 shows a modification of the configuration shown in FIGS. 6A and 7. In the configuration shown in FIG. 8, in the first mode, substrate contact portions 218a and 218b provided on an outer peripheral portion of the peripheral circuit region 203 are used for heating. Similar to the configuration shown in FIG. 6B, a plurality of contacts 239a may be arrayed along the side 242a of the rectangular pixel array region 202. In addition, a plurality of contacts 239b may be arrayed along the side 242b facing the side 242a along which the plurality of contacts 239a are arrayed. In the configuration shown in FIG. 8, the pixel array region 202 is provided between the contact 239a and the contact 239b.

The contacts 239a and 239b are contacts that are connected to the n-type substrate 201. The contact 239a is in contact with an n-type diffusion region 240a provided in the substrate contact portion 218a, and the contact 239b is in contact with an n-type diffusion region 240b provided in the substrate contact portion 218b. The diffusion region 240a is electrically connected to the terminal 206a via the contact 239a, the predetermined wiring layer 211, and the contact 213. The diffusion region 240b is electrically connected to the terminal 207a via the contact 239b, the predetermined wiring layer 211, and the contact 213. Other configurations may be the same as the respective configurations described above.

As indicated by the arrow in FIG. 8, a current flows from the terminal 206a to the terminal 207a through the contact 239a, the n-type diffusion region 240a, the n-type diffusion region 240b of the n-type substrate 201, and the contact 239b. This will heat the n-type substrate 201 and heat the photodiodes and the transistors of the plurality of pixels 216 provided in the pixel array region 202, thereby rectifying the characteristics of the radiation detection apparatus 100. In the configuration shown in FIG. 8, a current flows in the n-type diffusion regions 240a and 240b and the substrate 201, which differ in polarity from the p-type well 214 provided with the plurality of pixels 216.

In addition, thinning the pixel array region 202 of the semiconductor layer (the substrate 201) can suppress heat conduction from the pixel array region 202 to the peripheral circuit region 203 and efficiently heat the pixel array region 202.

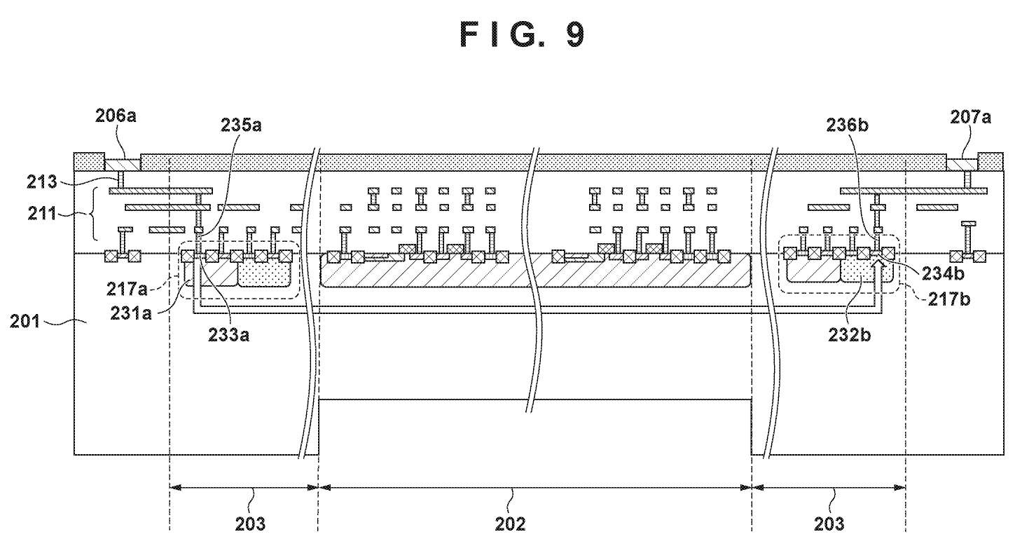

FIG. 9 shows a modification of the configuration shown in FIGS. 6A, 7, and 8. In the configuration shown in FIG. 9, in the first mode, protective diodes 217a and 217b provided in an outer edge portion of the peripheral circuit region 203 are used for heating. Similar to the configuration shown in FIG. 6B, a plurality of contacts 235a may be arrayed along the side 242a of the rectangular pixel array region 202. In addition, a plurality of contacts 236b may be arrayed along the side 242b facing the side 242a along which the plurality of contacts 235a are arrayed. In the configuration shown in FIG. 9, the pixel array region 202 is provided between a contact 235b and a contact 236b.

The contact 235a is in contact with a p-type diffusion region 233a in a p-type well 231a. The contact 236b is in contact with an n-type diffusion region 234b in an n-type well 232b. The diffusion region 233a is electrically connected to the terminal 206a via the contact 235a, the predetermined wiring layer 211, and the contact 213. The diffusion region 234b is electrically connected to the terminal 207a via the contact 236b, the predetermined wiring layer 211, and the contact 213. Other configurations may be the same as the respective configurations described above.

As indicated by the arrow in FIG. 9, a current flows from the terminal 206a to the terminal 207a through the contact 235a, the p-type diffusion region 233a, the p-type well 231a, the n-type substrate 201, an n-type well 232b, the n-type diffusion region 234b, and the contact 236b. This will heat the n-type substrate 201 and heat the photodiodes and transistors of the plurality of pixels 216 provided in the pixel array region 202, thereby rectifying the characteristics of the radiation detection apparatus 100.

A merit of using the protective diodes 217a and 217b when making a current flow in the first mode is that the wiring pattern of the wiring layer 211 connected to the protective diodes 217a and 217b is generally thick and high in current resistance. Another merit of using the protective diodes 217a and 217b is that the protective diodes 217a and 217b are not connected to the gate electrode of an active element and hence are resistant to breakdown by the application of a high voltage. In the configuration shown in FIG. 9, the contacts 235a and 236b are connected to the diffusion regions 233a and 234b as semiconductor regions having different polarities. This makes it possible to also use a pn-junction forward current when supplying power from a power source to the heating portion of a semiconductor layer without going through any active element. That is, it is possible to apply a voltage exceeding the withstand voltage of the active element between the terminal 206a and the terminal 207a and increase the amount of heat generated in the first mode of performing a deterioration rectifying operation.

The radiation detection apparatus 100 is driven in the second mode of performing a radiation detecting operation and is then switched to the first mode of rectifying the deterioration of the photodiode provided in the pixel 216. The configuration shown in FIG. 9 makes it possible to also use the protective diodes 217a and 217b used in the second mode as the path of a current used for heating in the first mode.

As described above, using the radiation detection apparatus 100 according to the present embodiment can rectify the deterioration of the photodiode as well as the transistor provided in the pixel 216. This makes it possible to improve the characteristics of the radiation detection apparatus 100.

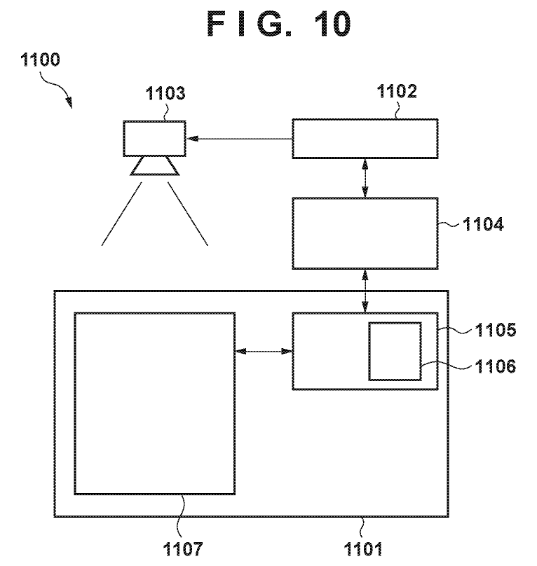

An example of application of the above radiation detection apparatus 100 to a radiation detection system and the like will be described next. FIG. 10 is a view showing a configuration example of a radiation detection system 1100 incorporating the radiation detection apparatus 100. The radiation detection system 1100 can include a radiation detector 1101, an exposure controller 1102, a radiation source 1103 that irradiates the radiation detector 1101 with radiation, and a computer 1104. The radiation detector 1101 includes an imaging unit 1107 including a plurality of pixels. As the radiation detector 1101, the radiation detection apparatus 100 described above can be used.

The radiation source 1103 starts irradiation with radiation in accordance with an exposure command supplied from the exposure controller 1102. The radiation emitted from the radiation source 1103 enters the imaging unit 1107 of the radiation detector 1101 through an imaging target. The radiation source 1103 stops the irradiation with radiation in accordance with a stop command from the exposure controller 1102.

The radiation detector 1101 can be a flat panel detector used for, for example, radiation imaging in medical image diagnosis or non-destructive inspection. The imaging unit 1107 of the radiation detector 1101 can have a plate-like shape with a size matching the size of an imaging target. For example, the imaging unit 1107 is provided with 3300 x 2800 pixels on a 550 mm x 445 mm substrate. The radiation detector 1101 may have a direct conversion type configuration that converts radiation into signal charge with a diode provided in the pixel array of the imaging unit 1107.

The radiation detector 1101 can include the imaging unit 1107, a controller 1105 for controlling the imaging unit 1107, and a signal processing unit 1106 for processing the signal output from the imaging unit 1107. For example, the signal processing unit 1106 may process the signal output from the imaging unit 1107 and output the processed signal as digital image data to the computer 1104. In addition, the signal processing unit 1106 may generate a stop signal for stopping irradiation with radiation from the radiation source 1103 based on the signal output from the imaging unit 1107. The stop signal is supplied to the exposure controller 1102 via the computer 1104. The exposure controller 1102 then sends a stop command to the radiation source 1103 in response to the stop signal.

The controller 1105 may be, for example, a programmable logic device (PLD) such as a field programmable gate array (FPGA) or an application specific integrated circuit (ASIC). Alternatively, the controller 1105 may be general-purpose computer incorporating programs. Alternatively, the controller 1105 may be a combination of all or some of these components.

The present embodiment has exemplified that the signal processing unit 1106 is provided in the controller 1105 or serves as part of the function of the controller 1105, but limitation is not made thereto. The controller 1105 and the signal processing unit 1106 may have different configurations. In addition, the signal processing unit 1106 may be provided independently of the radiation detector 1101. For example, the computer 1104 may have the same function as that of the signal processing unit 1106. Accordingly, the signal processing unit 1106 can be included in the radiation detection system 1100 as a signal processing device that processes the signal output from the radiation detector 1101.

The computer 1104 can control the radiation detector 1101 and the exposure controller 1102 and perform the processing for receiving radiation image data from the radiation detector 1101 and displaying the received data as a radiation image. The computer 1104 can function as an input unit for allowing the user to input conditions for imaging to obtain radiation images.

For example, the exposure controller 1102 has an exposure switch. When the user turns on the exposure switch, the exposure controller 1102 sends an exposure command to the radiation source 1103 and also sends a start notification indicating the start of irradiation with radiation to the computer 1104. Upon receiving the start notification, the computer 1104 notifies the controller 1105 of the radiation detector 1101 of the start of irradiation with radiation in response to the start notification. In accordance with this operation, the controller 1105 causes the imaging unit 1107 to generate a signal corresponding to the incident radiation.

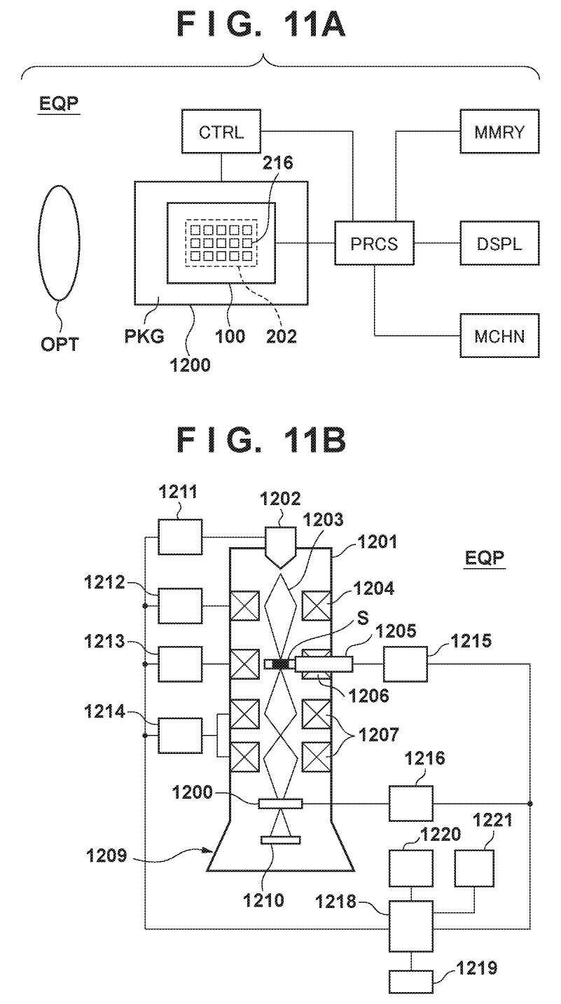

Another example of the radiation detection system incorporating the radiation detection apparatus 100 will be described next with reference to FIGS. 11A and 11B.

FIG. 11A shows equipment EQP as a radiation detection system including a radiation detector 1200 including the radiation detection apparatus 100 described above. The radiation detector 1200 includes a package PKG for mounting the radiation detection apparatus 100 in addition to the radiation detection apparatus 100 described above.

The equipment EQP can further include at least one of an optical system OPT, a control device CTRL, a processing device PRCS, a display device DSPL, a storage device MMRY, and a mechanical device MCHN. The optical system OPT forms an image of radiation on the radiation detector 1200, and is, for example, a lens, a shutter, and a mirror. The optical system OPT may form an image of a particle beam such as an electron beam or a proton beam on the radiation detector 1200 in accordance with the kind of radiation to be processed. The control device CTRL controls the radiation detector 1200, and is, for example, an ASIC. The processing device PRCS processes a signal output from the radiation detector 1200, and is, for example, a device such as a CPU or an ASIC for forming an Analog Front End (AFE) or a Digital Front End (DFE). The display device DSPL is an EL display device or a liquid crystal display device that displays, in a format such as a visible image, information obtained by the radiation detector 1200. The storage device MMRY is a magnetic device or a semiconductor device for storing information obtained by the radiation detector 1200. The storage device MMRY is a volatile memory such as an SRAM or a DRAM or a nonvolatile memory such as a flash memory or a hard disk drive. The mechanical device MCHN includes a moving or propulsion unit such as a motor or an engine.

In the equipment EQP, a signal output from the radiation detector 1200 is displayed on the display device DSPL, or transmitted to an external device by a communication device (not shown) included in the equipment EQP. Hence, the equipment EQP may further include the storage device MMRY and the processing device PRCS in addition to a storage circuit and an arithmetic circuit included in the radiation detector 1200. The mechanical device MCHN may be controlled based on the signal output from the radiation detector 1200.

The equipment EQP shown in FIG. 11A may be medical equipment such as an endoscope or radiation diagnostic equipment, measurement equipment such as a distance measurement sensor, or analysis equipment such as an electron microscope.

FIG. 11B is a schematic view showing the configuration of a Transmission Electron Microscope (TEM) as an example of the equipment EQP. The equipment EQP serving as an electron microscope includes an electron beam source 1202 (electron gun) as an irradiation unit of radiation (electron beams), an irradiation lens 1204, a vacuum chamber 1201 (lens barrel), an object lens 1206, and a magnifying lens system 1207. The equipment EQP also includes a camera 1209 as an imaging unit. The camera 1209 includes the radiation detector 1200 including the radiation detection apparatus 100 described above.

An electron beam 1203 as an energy beam emitted from the electron beam source 1202 is focused by the irradiation lens 1204, and irradiates a sample S as an analysis target held by a sample holder. A space through which the electron beam 1203 passes is formed by the vacuum chamber 1201 (lens barrel), and is held in vacuum. The radiation detector 1200 is arranged to face the vacuum space through which the electron beam 1203 passes. The electron beam 1203 transmitted through the sample S is magnified by the object lens 1206 and the magnifying lens system 1207, and projected to the radiation detector 1200. An electron optical system for irradiating the sample S with an electron beam is called an irradiation optical system, and an electron optical system for forming an image of the electron beam transmitted through the sample S on the radiation detector 1200 is called an imaging optical system.

The electron beam source 1202 is controlled by an electron beam source control device 1211. The irradiation lens 1204 is controlled by an irradiation lens control device 1212. The object lens 1206 is controlled by an object lens control device 1213. The magnifying lens system 1207 is controlled by a magnifying lens system control device 1214. A control mechanism 1205 of the sample holder is controlled by a holder control device 1215 configured to control a driving mechanism of the sample holder.

The electron beam 1203 transmitted through the sample S is detected by a direct electron detector 1200 of the camera 1209. A signal output from the direct electron detector 1200 is processed by a signal processing device 1216 and an image processing device 1218 serving as the processing device PRCS, thereby generating an image signal. The generated image signal (transmission electron image) is displayed on an image display monitor 1220 and an analysis monitor 1221 corresponding to the display device DSPL.

The camera 1209 is provided in the lower portion of the equipment EQP. The camera 1209 includes the radiation detector 1200 that directly converts an electron beam into a charge signal. At least part of the camera 1209 is provided in the camera 1209 so as to be exposed to the vacuum space formed by the vacuum chamber 1201. The electron beam 1203 transmitted through the radiation detector 1200 is absorbed by an electron beam absorbing member 1210. The camera 1209 can also be attached to and detached from the vacuum chamber 1201. In a case where the radiation detector 1200 needs to be replaced, the camera 1209 can be detached from the vacuum chamber 1201 and replaced with a new camera. An openable/closable vacuum partition may be provided between the camera 1209 and the vacuum chamber 1201 to replace the camera 1209 without breaking the vacuum of the vacuum chamber 1201.

Each of the electron beam source control device 1211, the irradiation lens control device 1212, the object lens control device 1213, the magnifying lens system control device 1214, and the holder control device 1215 is connected to the image processing device 1218. This allows them to exchange data in order to set the imaging condition of the electron microscope. In this case, the electron beam source control device 1211 and the image processing device 1218 function as a control means for controlling a radiation irradiation rate. By a signal supplied from the image processing device 1218, driving control of the sample holder and setting of the observation condition of each lens can be performed.

An operator prepares the sample S as an imaging target, and sets imaging conditions using an input device 1219 connected to the image processing device 1218. Predetermined data is input to each of the electron beam source control device 1211, the irradiation lens control device 1212, the object lens control device 1213, and the magnifying lens system control device 1214 to obtain a desired acceleration voltage, magnification, and observation mode. Furthermore, the operator inputs conditions such as the number of continuous visual field images, an imaging start position, and the moving speed of the sample holder to the image processing device 1218 using the input device 1219 such as a mouse, a keyboard, and a touch panel. The image processing device 1218 may automatically set the conditions regardless of the operator input.

The radiation detection system described above is merely exemplary, and the radiation detection apparatus 100 described above may be applied to another apparatus or system.

The present disclosure can provide a technique advantageous in rectifying deterioration.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-082855, filed May 16, 2025, which is hereby incorporated by reference herein in its entirety.

What is claimed is:

1. A radiation detection apparatus comprising:
a substrate including a semiconductor layer;
a detector including a pixel array region including a plurality of pixels provided in the semiconductor layer so as to detect radiation and a peripheral circuit region having a circuit provided in the semiconductor layer so as to drive the plurality of pixels; and
a plurality of terminals provided on the substrate and configured to connect the detector to outside of the detector,
wherein the plurality of terminals include a first terminal used for one of current input and output operations for heating the semiconductor layer and a second terminal used for the other of the current input and output operations, and
the current flows between the first terminal and the second terminal via part of the semiconductor layer.

2. The apparatus according to claim 1, further comprising a first contact that is in contact with the semiconductor layer so as to electrically connect the first terminal to the semiconductor layer and a second contact that is in contact with the semiconductor layer so as to electrically connect the second terminal to the semiconductor layer,
wherein at least one pixel of the plurality of pixels is provided between the first contact and the second contact in planar view.

3. The apparatus according to claim 2, wherein the plurality of pixels are provided between the first contact and the second contact in planar view.

4. The apparatus according to claim 2, wherein the pixel array region is provided between the first contact and the second contact in planar view.

5. The apparatus according to claim 2, wherein the first contact is in contact with a first semiconductor region of the semiconductor layer,
the second contact is in contact with a second semiconductor region of the semiconductor layer, and
the first semiconductor region and the second semiconductor region are regions having the same polarity.

6. The apparatus according to claim 2, wherein the first contact is in contact with a first semiconductor region of the semiconductor layer,
the second contact is in contact with a second semiconductor region of the semiconductor layer,
the first semiconductor region and the second semiconductor region are provided in a well, of the semiconductor layer, in which the plurality of pixels are provided, and
the first semiconductor region, the second semiconductor region, and the well are regions having the same polarity.

7. The apparatus according to claim 4, wherein the first contact is in contact with a first semiconductor region of the semiconductor layer,
the second contact is in contact with a second semiconductor region of the semiconductor layer, and
the first semiconductor region and the second semiconductor region are regions having the same polarity and differing in polarity from a well, of the semiconductor layer, in which the plurality of pixels are provided.

8. The apparatus according to claim 2, wherein the first contact is in contact with a first semiconductor region of the semiconductor layer,
the second contact is in contact with a second semiconductor region of the semiconductor layer, and
the first semiconductor region and the second semiconductor region are regions having different polarities.

9. The apparatus according to claim 2, further comprising:
a plurality of first contacts including the first contact; and
a plurality of second contacts including the second contact.

10. The apparatus according to claim 9, wherein the pixel array region has a rectangular shape including a first side and a second side provided so as to face each other,
the plurality of first contacts are provided along the first side, and
the plurality of second contacts are provided along the second side.

11. The apparatus according to claim 1, further comprising a control circuit configured to be able to control an operation of the detector in a plurality of operation modes,
wherein the plurality of operation modes include a first mode in which the control circuit performs control to make the current flow between the first terminal and the second terminal.

12. The apparatus according to claim 11, wherein in the first mode, the control circuit is configured to inhibit the plurality of pixels from operating.

13. The apparatus according to claim 11, wherein in the first mode, the control circuit is configured to perform control to make a terminal, of the plurality of terminals, which is used to operate the plurality of pixels float.

14. The apparatus according to claim 13, wherein the plurality of operation modes further include a second mode of operating the plurality of pixels, and
in the second mode, the control circuit is configured to perform control to supply a first potential to the first terminal and a second potential to the second terminal.

15. The apparatus according to claim 14, wherein the first potential and the second potential are equal to each other.

16. The apparatus according to claim 14, wherein the first potential and the second potential each are a ground-level potential.

17. The apparatus according to claim 14, wherein in the first mode, the control circuit is configured to perform control to supply a third potential to the first terminal, and
the third potential is higher than the first potential and the second potential.

18. The apparatus according to claim 11, wherein in the first mode, the control circuit is configured to perform control to make the current continuously flow for not less than 2 hr.

19. The apparatus according to claim 1, wherein making the current flow heats at least part of the pixel array region to not less than 80°C.

20. A radiation detection system comprising:
the radiation detection apparatus according to claim 1; and
a radiation source configured to irradiate the radiation detection apparatus with radiation.
